(19) United States
(12) Patent Application Publication
(10) Pub. No.: US 2006/0289634 A1
(43) Pub. Date: Dec. 28, 2006

(54) Automated cashier for a vehicle wash facility

(76) Inventor: Gilbert J. Rietsch JR., Clarkston, MI (US)

Correspondence Address: John R. Benefiel, Suite 100 B, 280 Daines Street, Birmingham, MI, 48009-6244, US

(21) Appl. No.: 11/182,604

(22) Filed: Jul. 15, 2005

Related U.S. Application Data
(60) Provisional application No. 60/588,660, filed on Jul. 15, 2004.

(51) Int. Cl. G06K 5/00; G07B 15/02

(52) U.S. Cl. 235/382; 235/384

(57) ABSTRACT

A vehicle wash facility having an automatic cashier for allowing access to the facility by a user only upon payment made to the automatic cashier, with a vehicle height detector creating a signal when a vehicle over a predetermined size is present, the signal causing the automatic cashier to require deposit of a greater fee payment to enable use of the wash facility.

### CROSS REFERENCE TO RELATED APPLICATIONS

This application claims the benefit of U.S. provisional application No. 60/588,660 filed on Jul. 15, 2004.

### BACKGROUND OF THE INVENTION

This invention concerns automated payment stations, i.e., automated cashiers, for vehicle wash facilities. Such automated cashiers are in widespread use with car washes where payment is made into the automated cashier by the customer either in the form of credit card, bills, or change. The auto cashier displays a menu of wash selections made by the customer prior to entry into a car wash facility with a cost associated with each selection. The auto cashier eliminates the need for a human attendant to collect the fees.

Some businesses charge an extra fee for larger vehicles such as pickups and large SUV's. In the past, this has required the presence of a staff person to collect the appropriate fee.

It is the object of the present invention to enable charging of different fees at a vehicle wash facility for different sized vehicles without requiring an attendant.

### SUMMARY OF THE INVENTION

The above object and other objects which will become apparent upon a reading of the specification and claims are achieved by incorporating a vehicle height sensor arrangement. which automatically senses when a vehicle over a predetermined height has pulled into the entrance way and moves next to an automated cashier. The menu choice charges displayed change if a vehicle over a predetermined height is detected. The different fee charged is determined by the programming of the automated cashier, as a correspondingly different set of menu prices.

The height detector may utilize an infrared beam from an emitter directed at an angle across the entryway lane at a height which will be blocked by large vehicles but pass over standard sized vehicles. A receptor receives the beam if a standard size or smaller vehicle enters the cashier station and the basic menu charges are displayed. If the beam is blocked, the receptor generates a signal causing the second menu to be illuminated and activated which displays the higher fee which must be deposited in order to enable use of the wash facility.

### DESCRIPTION OF THE DRAWINGS

FIG. 1 is a plan view of a three gated wash facility and entranceway incorporating a vehicle height detector arrangement.

FIG. 2 is pictorial view of the vehicle wash facility shown in FIG. 1.

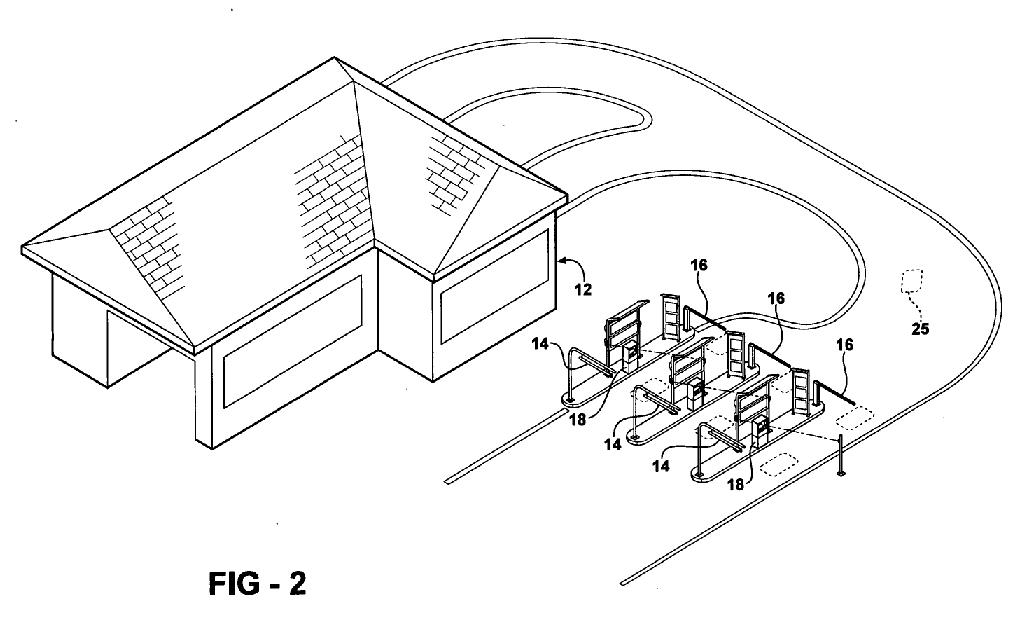

FIG. 3 is an enlarged pictorial view of the three gate entranceway shown in FIGS. 1 and 2.

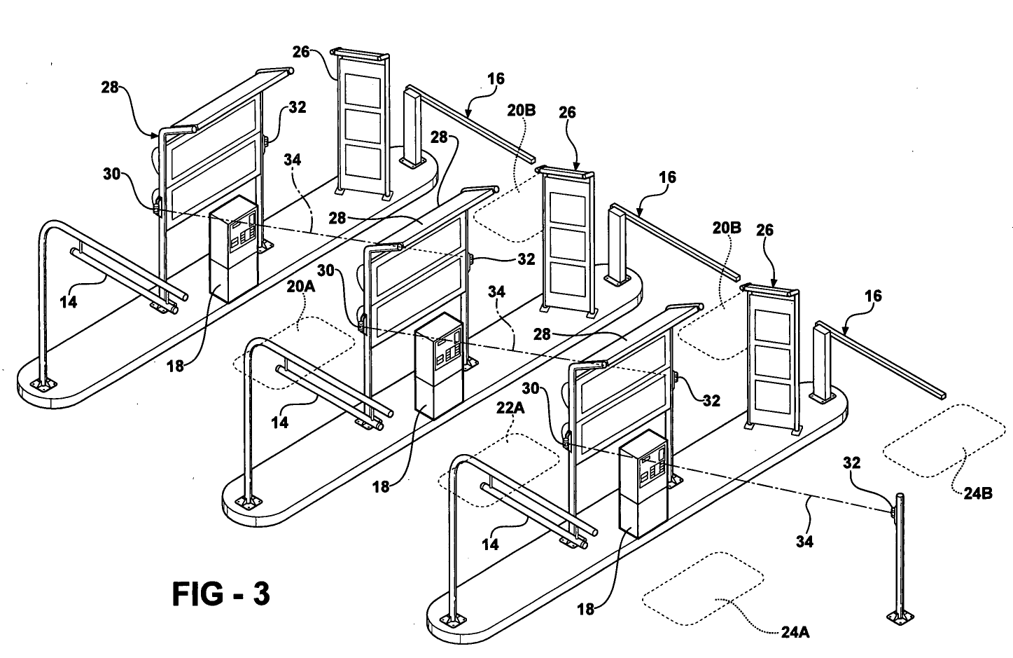

FIG. 4 is an enlarged plan view of an entranceway and a conveyor for a vehicle wash facility incorporating the vehicle height sensor arrangement according to the teachings of the invention, with a vehicle shown in phantom lines.

FIG. 5 is a pictorial view of the entranceway and conveyor shown in FIG. 4.

FIG. 6 is a pictorial view of an infrared light beam emitter mounted on a support post.

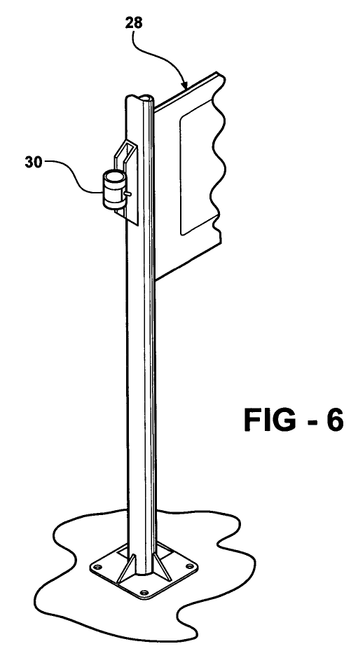

FIG. 7 is a front view of an auto cashier screen incorporating a dual menu for different sized vehicles according to the teachings of the present invention.

### DETAILED DESCRIPTION

In the following detailed description, certain specific terminology will be employed for the sake of clarity and a particular embodiment described in accordance with the requirements of 35 USC § 112, but it is to be understood that the same is not intended to be limiting and should not be so construed inasmuch as the invention is capable of taking many forms and variations within the scope of the appended claims queuing.

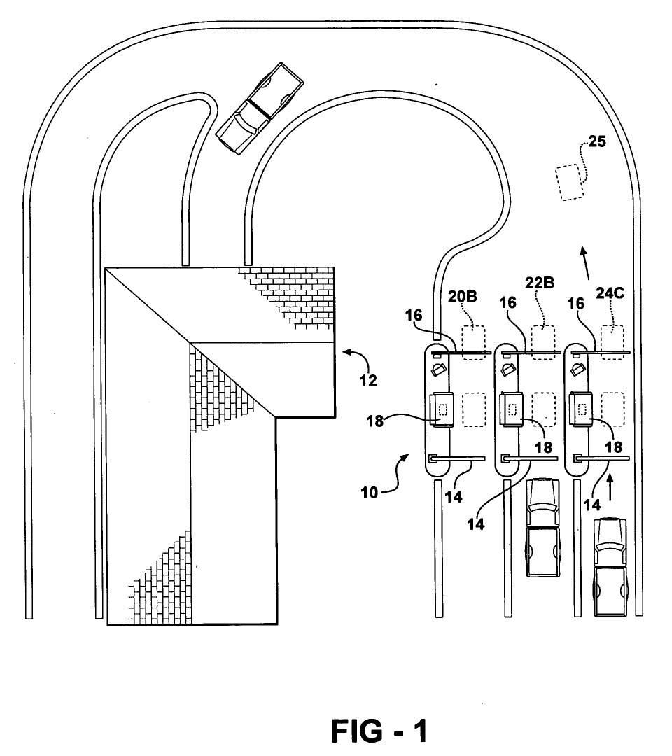

Referring to the drawings, FIG. 1 depicts a multi-lane entranceway 10 to a vehicle wash facility 12. The entranceway 10 includes automatically operated access gates 16 located past an auto cashier kiosk 18. Upon deposit of a payment by a user of the facility, the gateway 16 opens automatically, subject to operation of a conventional queuing program. An overhead vehicle height limiting barrier 14 is located ahead of the kiosk 18.

Buried vehicle detectors 20A, 20B, 22A, 22B, 24A, and 24B, and 25 are used to sense the presence of a vehicle at different locations for use in managing the entrance of vehicles into the facility 12. Backlit advertising and traffic direction panels are typically held in supports 26, 23.

According to the concept of the present invention, each entranceway 10 is provided with a vehicle height detector arrangement, each here comprised of an infrared beam emitter 30 aligned with a receptor 32.

These components are arranged to direct a horizontal light beam 34 angled across the lane in the region alongside the auto cashier kiosk 18. The angling of the beam avoids any possible penetration of the light beam through the vehicle windows or through clearance spaces as between a pickup truck bed and cabin.

The emitters 30 and receptor 32 are set at a predetermined height, i.e., 60 inches, to distinguish between vehicles of standard or oversized heights for which a higher fee is to be charged for a wash. The deposit of a higher fee amount is also required to open the access gateway 10 or to activate a conveyor. If the receptor 32 detects a beam, lower fees will be displayed by the cashier as will be described below.

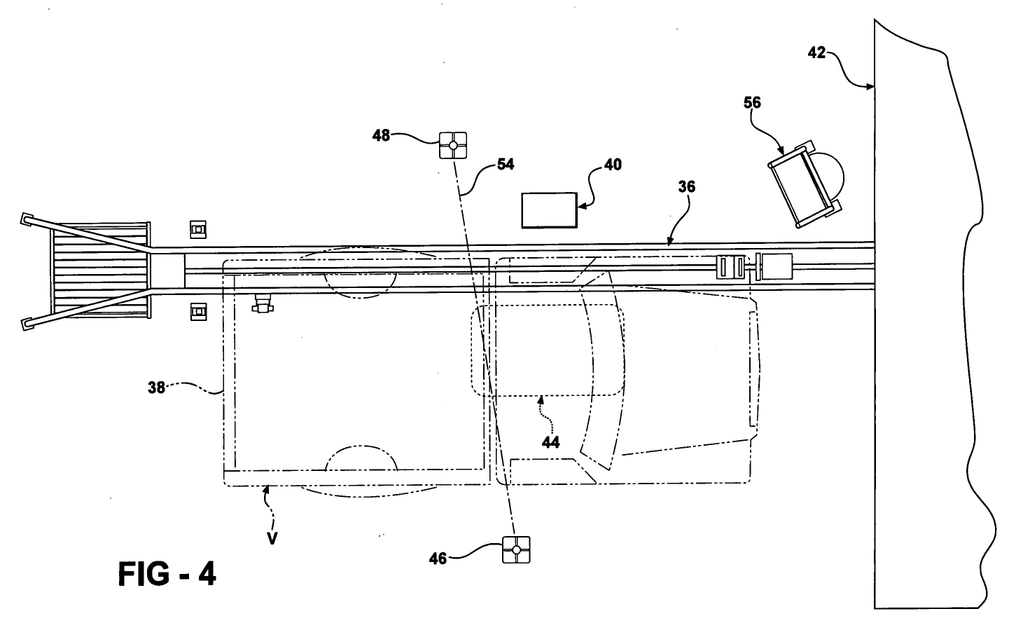

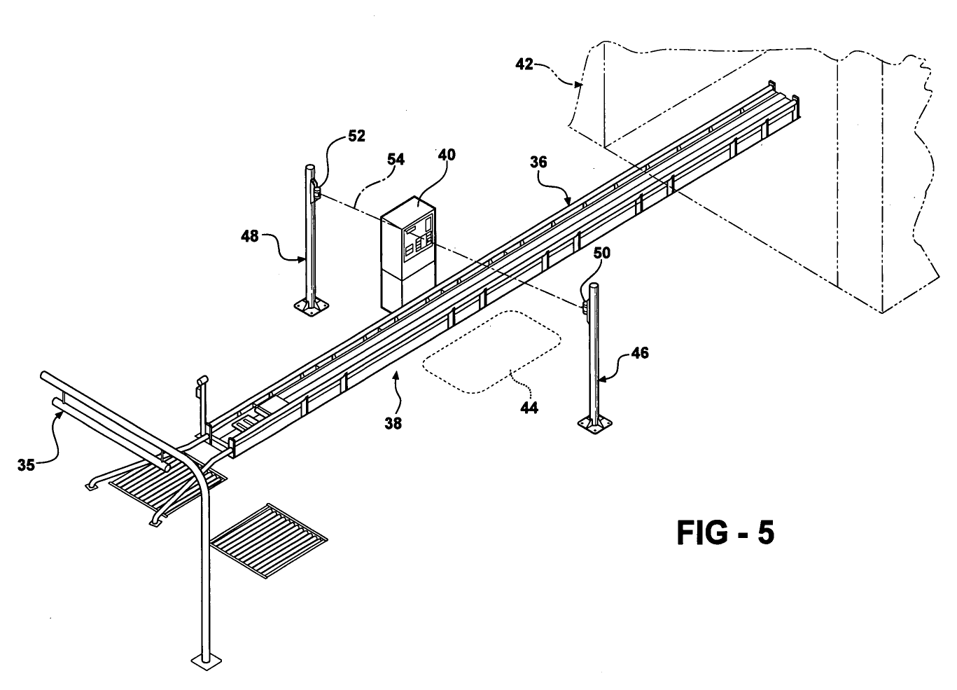

FIGS. 4 and 5 show an entranceway 38 in which the vehicle V has driven past an over head height limiter 35 onto a conventional wheel conveyor 36, extending past an automated cashier kiosk 40 to enter a vehicle wash facility 42. A buried vehicle presence detector 44 is typically provided to detect the presence of the vehicle in the entranceway 38.

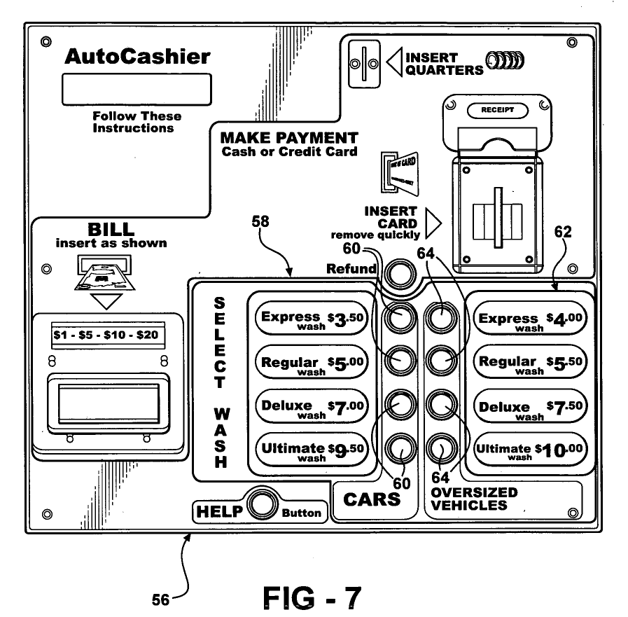

A pair of uprights 46 48 respectively mount an infrared emitter 50 and an aligned receptor 52 at a predetermined height above the pavement. A horizontal infrared beam 54 is thereby directed across the entranceway 38 at an angle as shown in FIG. 4. A back lit sign is typically proved to give instructions to the driver (FIG. 4). A cashier display 56 as typically configured is shown in FIG. 7. According to the concept of the invention, the menu 50 to the left is for cars and is normally illuminated and the touch switches 60 enabled as long as receptors 30, 52 sense the associated beam 34 or 54.

Upon interruption of the beams 34, 54 by the presence of an oversized vehicle, the system is programmed to respond to a signal generated by the height detector arrangement to cause illumination of the right side menu 62 and the touch switches 64 are enabled. The fees charged are higher on the menu 62. Thus the presence of an attendant is not required.

It should be understood that other detector arrangements could be used, such as those utilizing ultrasonic or laser beams, mechanical switches, magnetic height proximity detectors, etc.

1. In combination with an automatic vehicle wash facility, an entranceway controlling movement of vehicles into said facility;
an automatic cashier at said entranceway allowing access only upon depositing a pre-programmed fee payment into said automatic cashier to enable entrance of a vehicle into said wash facility;
a vehicle height detector in said entranceway providing a signal when a vehicle is over a predetermined size;
said automatic cashier responsive to said signal to require payment of a greater fee therein to enable entrance of said vehicle into said vehicle wash facility.

2. The combination according to claim 1 wherein said automatic cashier includes two wash selection menus each corresponding to a regular or oversized vehicle, with a one of said menu having a set of touch switches activated only when the presence of an oversized vehicle in said entranceway is not detected and a second selection menu having a set of touch switches activated only when an oversized vehicle in said entranceway is detected.

3. The combination according to claim 2 wherein each menu is illuminated only when the associated set of touch switches are enabled.
